(19) United States
(12) Patent Application Publication
(10) Pub. No.: US 2007/0131661 A1
(43) Pub. Date: Jun. 14, 2007

(54) Solder ball placement system

(76) Inventor: Steven F. Reiber, Rocklin, CA (US)

Correspondence Address: CARR & FERRELL LLP, 2200 GENG ROAD, PALO ALTO, CA, 94303, US

(21) Appl. No.: 11/582,826

(22) Filed: Oct. 17, 2006

Related U.S. Application Data
(63) Continuation-in-part of application No. 11/107,308, filed on Apr. 15, 2005, now Pat. No. 7,124,927.
Application No. 11/107,308 is a continuation-in-part of application No. 10/942,311, filed on Sep. 15, 2004.
Application No. 11/107,308 is a continuation-in-part of application No. 10/943,151, filed on Sep. 15, 2004, now Pat. No. 7,032,802.
Application No. 10/943,151 is a continuation-in-part of application No. 10/650,169, filed on Aug. 27, 2003, now Pat. No. 6,935,548.
Application No. 10/650,169 is a continuation of application No. 10/036,579, filed on Dec. 31, 2001, now Pat. No. 6,651,864.
Application No. 10/650,169 is a continuation-in-part of application No. 09/514,454, filed on Feb. 25, 2000, now Pat. No. 6,354,479.
(60) Provisional application No. 60/288,203, filed on May 1, 2001.
(60) Provisional application No. 60/121,694, filed on Feb. 25, 1999.
(60) Provisional application No. 60/503,267, filed on Sep. 15, 2003.

(51) Int. Cl. B23K 1/005

(52) U.S. Cl. 219/121.63; 219/121.83

(57) ABSTRACT

A solder ball placement system including a singulation unit and bond head for delivery of solder balls to a chip or substrate is disclosed. The bond head includes a tool tip configured to conduct electricity at a rate sufficient to prevent charge buildup but not at so high a rate as to overload a device being bonded to the substrate or chip.

### CROSS REFERENCE TO RELATED APPLICATIONS

This application is a continuation-in-part and claims the priority benefit of U.S. patent application Ser. No. 11/107,308 filed Apr. 15, 2005 and entitled “Flip Chip Bonding Tool and Ball Placement Capillary,” which is now U.S. Pat. No. 7,124,927; U.S. patent application Ser. No. 11/107,308 is a continuation-in-part and claims the priority benefit of U.S. patent application Ser. No. 10/942,311 filed Sep. 15, 2004 entitled “Flip Chip Bonding Tool Tip”; U.S. patent application Ser. No. 11/107,308 is also a continuation-in-part and claims the priority benefit of U.S. patent application Ser. No. 10/943,151 filed Sep. 15, 2004 and entitled “Bonding Tool with Resistance,” which is now U.S. Pat. No. 7,032,802; U.S. patent application Ser. No. 10/942,311 and U.S. patent application Ser. No. 10/943,151 are both continuations-in-part and claim the priority benefit of U.S. patent application Ser. No. 10/650,169 filed Aug. 27, 2003 and entitled “Dissipative Ceramic Bonding Tool Tip,” which is now U.S. Pat. No. 6,935,548; U.S. patent application Ser. No. 10/650,169 is a continuation and claims the priority benefit of U.S. patent application Ser. No. 10/036,579 filed Dec. 31, 2001 and entitled “Dissipative Ceramic Bonding Tool Tip,” which is now U.S. Pat. No. 6,651,864; U.S. patent application Ser. No. 10/036,579 claims the priority benefit of U.S. provisional patent application No. 60/288,203 filed May 1, 2001; U.S. patent application Ser. No. 10/036,579 is also a continuation-in-part and claims the priority benefit of U.S. patent application Ser. No. 09/514,454 filed Feb. 25, 2000 and entitled “Dissipative Ceramic Bonding Tool Tip,” which is now U.S. Pat. No. 6,354,479; U.S. patent application Ser. No. 09/514,454 also claims the priority benefit of U.S. provisional patent application No. 60/121,694 filed Feb. 25, 1999; U.S. patent application Ser. No. 10/942,311 and U.S. patent application Ser. No. 10/943,151 also claim the priority benefit of U.S. provisional patent application No. 60/503,267 filed Sep. 15, 2003 and entitled “Bonding Tool.” The contents of all of these applications are incorporated herein by reference.

### BACKGROUND OF THE INVENTION

1. Field of the Invention

The present invention relates to flip chip bonding tool tips. More particularly, the present invention relates to dissipative and insulative ceramic flip chip bonding tools and capillaries for ball placement for bonding electrical connections.

2. Description of the Prior Art

Integrated circuits have different methods of attachment to a lead frame. One method is an ultrasonic wire bond whereby individual leads are connected to individual bond pads on the integrated circuit with wire. Ball bonding—a type of wire bonding—involves a process whereby a sphere of gold is melted on a length of wire. Wedge bonding is similar to ball bonding except that the process generally utilizes aluminum wire; no ‘ball’ is formed and the process can be performed at room temperature. Gold ball bonding, on the other hand, typically occurs at temperatures in excess of 150° Celsius. Gold ball bonding is most often used in high volume applications as it is a faster process whereas aluminum wire bonding is used in situations when packages or a printed circuit board cannot be heated. Gold ball bonding, too, has pitch limits of approximately 60 micron. Aluminum wedge bonding can be performed as pitches finer than 60 micron.

Wire bonding techniques use “face-up” chips with a wire connection to each pad. Bump or “flip chip” microelectronic assembly, on the other hand, is a direct electrical connection of face-down—“flipped”—electronic components onto substrates, circuit boards, or carriers by means of conductive bumps on a chip bond pad.

Flip chip components are predominantly semiconductor devices. Components such as passive filters, detector arrays, and MEMs devices are also used in flip chip form. Flip chip is sometimes referred to as Direct Chip Attach (DCA) as the chip is attached directly to the substrate, board, or carrier by the conductive bumps. Automotive electronics, electronic watches, and a growing percentage of cellular phones, pagers, and high speed microprocessors are assembled with flip chips.

The bump serves several functions in the flip chip assembly. Electrically, the bump provides the conductive path from chip to substrate. The bump also provides a thermally conductive path to carry heat from the chip to the substrate. In addition, the bump provides part of the mechanical mounting of a die to the substrate. The bump also provides a spacer, preventing electrical contact between the chip and substrate conductors, and acting as a short lead to relieve mechanical strain between board and substrate.

Gold stud bumps are placed on die bond pads through a modification of the “ball bonding” process used in conventional wire bonding or by the use of a ball placement machine where small balls are forced down a small capillary onto a pad and then laser reflowed. In the ball bonding referenced above, a tip of a gold bond wire is melted to form a sphere. A wire bonding tool presses this sphere against an aluminum bond pad, applying mechanical force, heat, and ultrasonic energy to create a metallic connection.

For gold stud bumping, the first ball bond is made as described but the wire is then broken close above the ball. The resulting gold ball, or “stud bump” remaining on the bond pad provides a permanent and reliable connection through the aluminum oxide to the underlying metal. After placing the stud bumps on a chip, the stud bumps may be flattened—“coined”—by mechanical pressure to provide a flatter top surface and more uniform bump heights while pressing any remaining wire tail into the ball. Each bump may be coined by a tool immediately after forming or all bumps on the die may be simultaneously coined by pressure against a flat surface in a separate operation following bumping.

Bonding tool tips must be sufficiently hard to prevent deformation under pressure, and mechanically durable so that many bonds can be made before replacement. Typical flip chip bonding tips available on the market today are made of a tungsten carbide or titanium carbide. These conducting tools are very hard compounds that have been successfully used on commercial machines as these compounds provide a reasonably long life in use as a flip chip bonding tool and ball placement capillary.

The problem, however, is that an electrostatic discharge (ESD) from the bonding tool or transient currents from the machine can damage the very circuit the tool is bonding. Flip chip bonding and ball placement capillaries tools must be electrically designed to produce a reliable electrical contact, yet prevent electrostatic discharge damage to the part being bonded. Certain prior art devices have a one-or-more volt emission when the tip makes bonding contact. This could present a problem as a one-volt static discharge can generate a 20 milliamp current to flow, which, in certain instances, can cause the integrated circuit to fail due to this unwanted current.

### SUMMARY OF THE INVENTION

An exemplary embodiment of the present invention provides for a solder ball placement system. The system includes a singulation unit for singulating solder balls for use by the system. In some embodiments, the diameter of the solder balls may be between 100 μm and 760 μm. The system further includes a bond head for receipt of the solder balls and for delivering the balls to a substrate or chip. Some embodiments of the present invention provide for the bond head to sequentially solder a series of solder balls. The bond head includes a tool tip that conducts electricity at a rate sufficient to prevent charge buildup but not at so high a rate as to overload a device being bonded to the substrate or chip. The bond head further includes a capillary for positioning the solder balls on the substrate or chip.

The bond head may move on an x-y-z-axis. Control of the bond head on those axes may come from instructions generated by a computing device offering directional control of the bond head. A user of the ball placement system may utilize the computing system to control the bond head.

In some embodiments, the tool tip may include a uniform extrinsic semi-conducting material on an insulator. Other embodiments may find the tool tip to include a thin layer of a highly doped semi-conductor on an insulating core. Further embodiments may utilize (on the tool tip) a lightly doped semi-conductor layer on a conducting core.

Some embodiments of the solder ball placement system may further include an optical sensor that, in conjunction with the bond head, operates to optimize the accurate placement of the solder balls on the substrate or chip. Other embodiments of the present invention may include a laser. The laser may be used as a target light for locating and subsequently placing solder balls on the chip or substrate. The laser may also be used in conjunction with the optical sensor and the bond head to further optimize placement of solder balls on the substrate or chip. In some embodiments of the present invention, the aforementioned laser may be a solid state, pulsed Nd:YAG laser. Embodiments of the laser may include a wavelength of approximately 1064 nm; laser energy of 4 J; a pulse frequency of 10 Hz; and a width of approximately 1 ms to 20 ms. The laser may, in some embodiments, be used to melt a solder ball thereby wetting the chip or substrate for an improved interface with a device being bonded.

Some embodiments of the present solder ball placement system may include a pressure sensor. The pressure sensor may determine when a solder ball has been sufficiently coined on a substrate or chip. The solder ball placement system may also include a vacuum ejector to control ejection of solder balls to the substrate or chip.x

### BRIEF DESCRIPTION OF THE DRAWINGS

FIG. 1 is a cross-sectional view of a flip chip bonding tool tip;

FIG. 2 is an enlarged, cross-sectional view of the flip chip bonding tool of FIG. 1;

FIG. 3 is an exemplary ball placement capillary system;

FIG. 4 is an exemplary method for manufacturing a dissipative flip chip bonding tool through the use of mixing, molding, and sintering reactive powders;

FIG. 5 is an exemplary method for manufacturing a dissipative flip chip bonding tool tip through the use of hot pressing reactive powders; and

FIG. 6 is an exemplary method for manufacturing a dissipative flip chip bonding tool tip through fusion casting.

FIG. 7 is an exemplary method for utilizing the presently described solder ball placement system.

### DETAILED DESCRIPTION

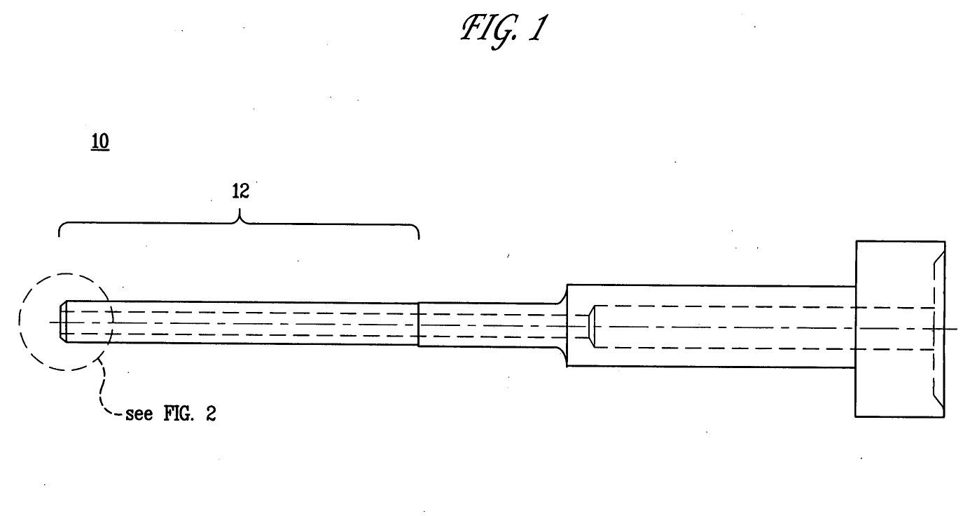

FIG. 1 illustrates an embodiment of a flip chip bonding tool 10. In one embodiment, the bonding tool is about two inches (30 to 80 mm) long and about 0.124 inch (3.0 mm) in diameter. An exemplary bonding tool tip 12, itself, is from 3 to 100 mils (0.8 to 2.54 mm) long. Running a length of the tool, but not viewable in FIG. 1, is a tube hole, which will accommodate a vacuum to, for example, pick up a tool.

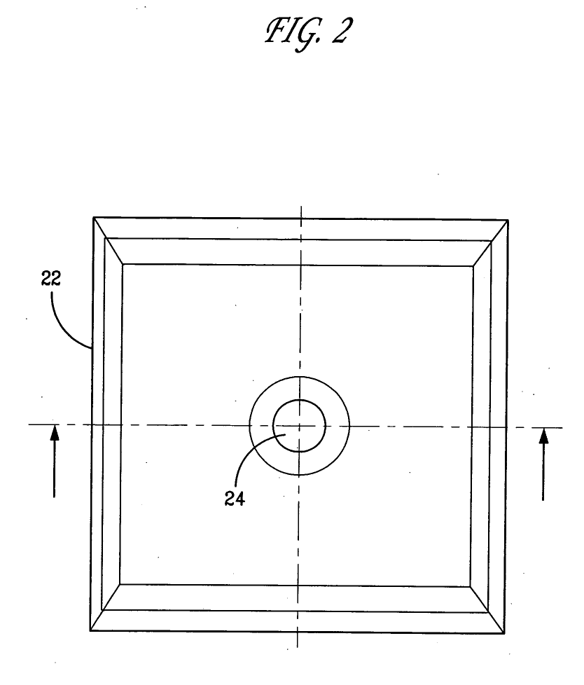

FIG. 2 is an enlarged, cross-sectional view of the flip chip bonding tool 10 of FIG. 1. Only that portion of the bonding tool 10 shown within the dotted circle in FIG. 1 is shown in FIG. 2. As shown, tool tip 22 has a tube hole 24, which may run an entire length of the bonding tool 10.

In accordance with principles of the present invention, to avoid damaging delicate electronic devices by an electrostatic discharge, a bonding tool tip conducts electricity at a rate sufficient to prevent charge buildup but not at so high a rate as to overload a device being bonded. It has been determined that the tool should have electrical conduction greater than one ten-billionth of a mho (i.e., >1×10⁻¹⁹ reciprocal ohms), but the tool's electrical conductivity should be less than one one-hundred thousandth of a mho (i.e., <1×10⁻² reciprocal ohms). Further, the tool's resistance should be low enough that the material is not an insulator and does not allow for any dissipation of charge, but high enough that the material does not allow a transient current to flow through to the device being bonded. In one embodiment of the present invention, a resistance in the tip assembly ranges from 10² to 10¹⁹ ohms depending on the part being bonded. Five (5) milliamps of current will, generally, damage present-day magnetic recording heads. Preferably, for today's magnetic recording heads, no more than 2 to 3 milliamps of current should be allowed to pass through the tip to the ground.

The tools should also have specific mechanical properties to function satisfactorily. Due to high stiffness and high abrasion resistance requirements, ceramics (e.g., electrical non-conductors) or metals, such as tungsten carbide (e.g., electrical conductor) have emerged as preferred materials. In one embodiment, the tip comprises a Rockwell hardness of about 55 or above. More preferably, in an embodiment, the Rockwell hardness is about 85 or above. In an embodiment of the present invention, the tip lasts for approximately fifteen thousand bondings.

In the present invention, flip chip bonding tool and ball placement capillaries with the desired electrical conduction can be made with three different configurations.

First, the tools may be made from a uniform extrinsic semi-conducting material or insulator, which has dopant atoms in appropriate concentrations and valence states to produce sufficient mobile charge carrier densities—unbound electrons or holes. Sufficient mobile charge carrier densities result in electrical conduction in a desired range. Silicon carbide uniformly doped with boron is an example of such a uniform extrinsic semi-conducting material. Silicon nitride is a further example of a uniform non-conducting material. Polycrystalline silicon carbide uniformly doped with boron is yet another example of such a uniform extrinsic semi-conducting material.

Second, the tools may be made by forming a thin layer of a highly doped semi-conductor on an insulating core. In this instance, the core provides mechanical stiffness, and the semi-conductor surface layer provides abrasion resistance and a charge carrier path from tip to a mount. This resistance and carrier path will permit dissipation of electrostatic charge at an acceptable rate. A diamond tip wedge that is ion implanted with boron is an example of such a thin layered tool.

Third, the tools may be made by forming a lightly doped semi-conductor layer on a conducting core. The conducting core provides mechanical stiffness and the semi-conductor layer provides abrasion resistance and a charge carrier path from tip to conducting core, which is electrically connected to the mount. The doping level is chosen to produce conductivity through the layer which will permit dissipation of electrostatic charge or stop all transient current at an acceptable rate. A cobalt-bonded tungsten carbide coated with titanium nitride carbide is an example of such a lightly doped tool.

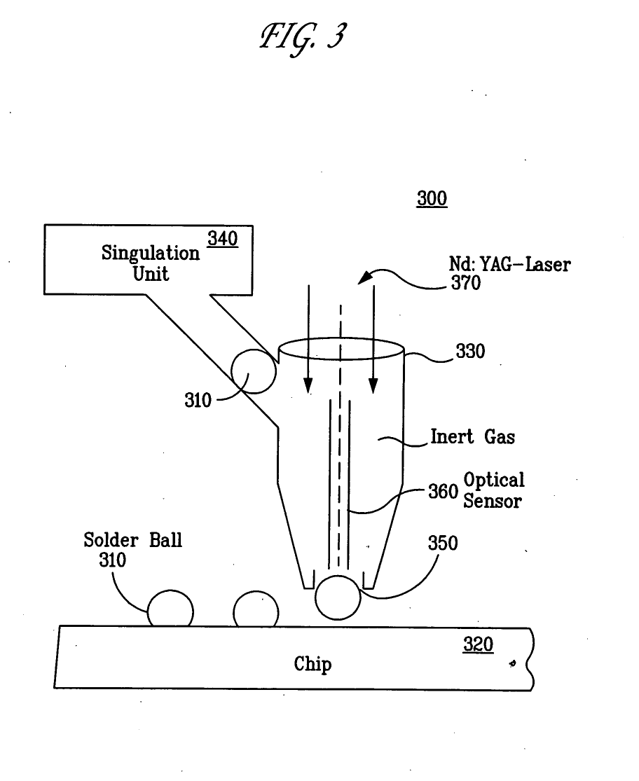

FIG. 3 is an exemplary ball placement capillary system 300. The ball placement capillary system 300 sequentially solders a ball to a variety of different microelectronic substrates. An embodiment of the invention may singulate, position, and reflow solder balls 310 on a chip 320 with a diameter between 100 μm and 760 μm.

Capillary system 300 comprises a bondhead 330 coupled to a singulation unit 340, a capillary 350 for ball positioning, an optional optical sensor 360, and a laser system 370.

Some embodiments of the capillary system 300 may further comprise a pressure sensor (not shown) and various vacuum capabilities (not shown), for example, a vacuum ejector. The pressure sensor may be used, for example, with respect to coining and determining whether a solder ball has been sufficiently coined as may be observed from various readings generated by the sensor and observable at, for example, a computing device coupled to the system. The vacuum ejector may be utilized to introduce balls into the bond head or, further, to aid in their placement on a substrate or chip by, for example, eliminating vacuum pressure.

Bondhead 330 is further coupled to a solder ball loading station (not shown). The bondhead 330 is the mechanical apparatus generally responsible for physical delivery of solder balls to various locales on a chip or substrate. Bondheads 330 are usually configured to deliver a particular size of solder ball typically ranging in size from 100 μm to 760 μm. The bondhead 330 is generally configured, in exemplary embodiments, to travel on an X-, Y-, and Z-axis. The exemplary bondhead 330 is typically controlled by a general computing device coupled to a keyboard or joystick to allow for directional control by a user or operator of the capillary system 300.

Singulation unit 340 operates to queue and subsequently deliver individual solder balls 310 to the capillary 350 for physical delivery and placement on the chip 320. Singulation unit 340 may operate in conjunction solder ball loading station (not shown). Capillary 350 serves to provide a physical channel for ejection of a solder ball onto chip 320 or other substrate surface. Optical sensor 360 operates to optimize placement of the solder ball 310 on the chip 320 and may operate on conjunction with the bond head either as an integrated element or a separate component that may work in conjunction with, for example, a computing device controlling the movements of the bond head along various axes.

Laser system 370 may utilize a pointing laser as a target light for precise location of the reflowed solder ball 310 on the chip 320 and may operate in conjunction with optical sensor 360 to further optimize precise solder ball 310 placement. One embodiment of laser system 370 comprises a solid state, pulsed neodymium:yttrium-aluminum-garnet (Nd:YAG) laser. In a Nd:YAG laser, a cylindrical rod of yttrium-aluminum-garnet doped with neodymium is the active medium. Such a laser may comprise a wavelength of approximately 1064 nm, laser energy of 4 J and a pulse frequency and width of up to 10 Hz and 1 ms to 20 ms, respectively. The laser system 370 also is operative to melt the solder ball 310 thereby wetting the chip 320 to provide a sufficient interface.

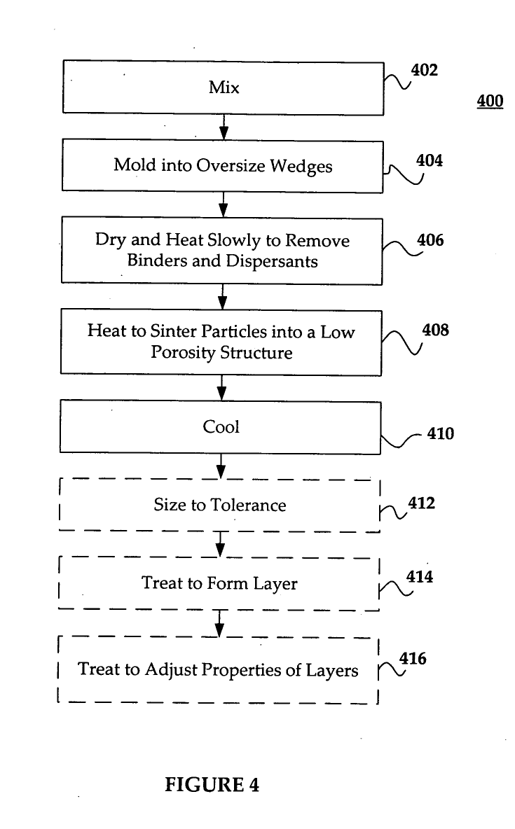

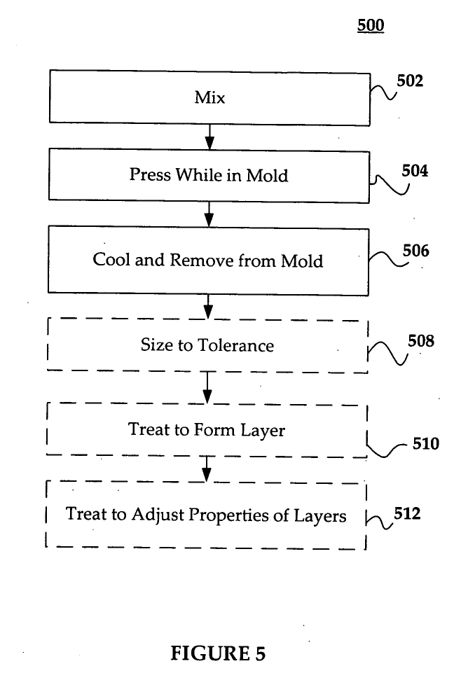

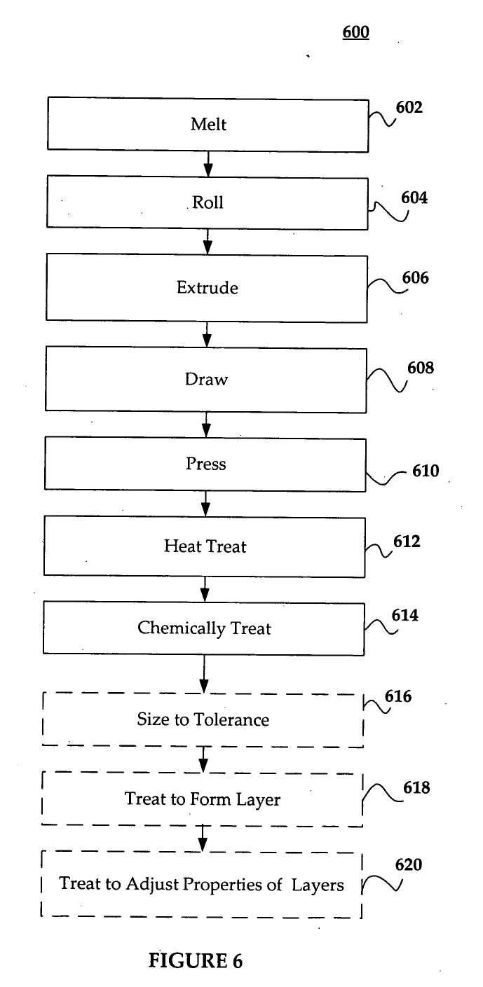

Dissipative tools can be manufactured through the use of mixing, molding, and sintering reactive powders as shown in the flowchart of FIG. 4; the use of hot pressing reactive powders as shown in the flowchart of FIG. 5; and through fusion casting as shown in the flowchart of FIG. 6.

Through the use of mixing, molding, and sintering reactive powders (flowchart 400 of FIG. 4), fine particles of a desired composition are mixed 402 with organic and inorganic solvents, dispersants, binders, and sintering aids and then molded 404 into oversized wedges. The wedges are carefully dried and slowly heated to a temperature between 500-2500 degrees Celsius 406 to remove the binders and dispersants. The wedges are then heated to a high enough temperature so that individual particles sinter together 408 into a solid structure with low porosity. The heat-treating atmosphere is chosen to facilitate the removal of the binder at a low temperature and to control valence of dopant atoms at a higher temperature and while cooling. After cooling 410, the wedges may be optionally machined, or otherwise sized, 412 to achieve required tolerances.

The wedges may then be optionally treated 414 to produce a desired surface layer by ion implementation, vapor deposition, chemical vapor deposition, physical deposition, electroplating deposition, neutron bombardment, or combinations of the above. The pieces may optionally be subsequently heat treated 416 in a controlled atmosphere (e.g., 2000 to 2500 degrees Celsius for 3 to 5 minutes) to produce the desired layer properties through diffusion, re-crystallization, dopant activation, or valence changes of metallic ions.

Through the use of hot pressing reactive powders (flowchart 500 of FIG. 5), fine particles of a desired composition are mixed 502 with binders and sintering aids and then pressed 504 in a mold at a high enough temperature (e.g., 1000 to 4000 degrees Celsius) to cause consolidation and binding of the individual particles into a solid structure with low porosity. The hot pressing atmosphere is chosen to control valence of dopant atoms. After cooling and removal 506 from the hot press mold, the pieces may optionally be machined, or otherwise sized, 508 to achieve required tolerances. The pieces may then be optionally treated 510 to produce a desired surface layer by ion implantation, vapor deposition, chemical vapor deposition, physical deposition, electo-plating deposition, neutron bombardment, or combinations of the above. The pieces may optionally be subsequently heat treated 512 in a controlled atmosphere to produce desired layer properties through diffusion, re-crystallization, dopant activation, or valence changes of metallic ions.

Through fusion casting (flowchart 600 of FIG. 6), metals of a desired composition are melted 602 in a non-reactive crucible then cast into an ingot. The ingot is then rolled 604, extruded 606, drawn 608, pressed 610, heat-treated 612 in a suitable atmosphere, and chemically treated 614. The pieces may then optionally be machined, or otherwise sized, 616 to achieve required tolerances. The metallic pieces may also be optionally heat-treated to produce a desired surface layer 618 by vapor deposition, chemical vapor deposition, physical deposition, electro-plating deposition, or combinations of the above. The pieces may optionally be subsequently heat-treated in a controlled atmosphere to produce desired layer properties 620 through diffusion, re-crystallization, dopant activation, or valence changes of metallic ions.

In an embodiment of the invention, the layer used in the bonding process could be a formula for dissipated or insulative ceramic comprising alumina (aluminum oxide Al₂O₃) and zirconia (zirconium oxide ZrO₂) and other elements or a silicon carbide with boron. This mixture is both somewhat electrically conductive and mechanically durable. The tip of a bonding tool can be coated with this material or the tip can be made completely out of this material. The shape of the tip may be wedge- or circular-shaped.

The bonding tip of the present invention may be used for any number of different types of bonding including ultrasonic and thermal flip chip bonding.

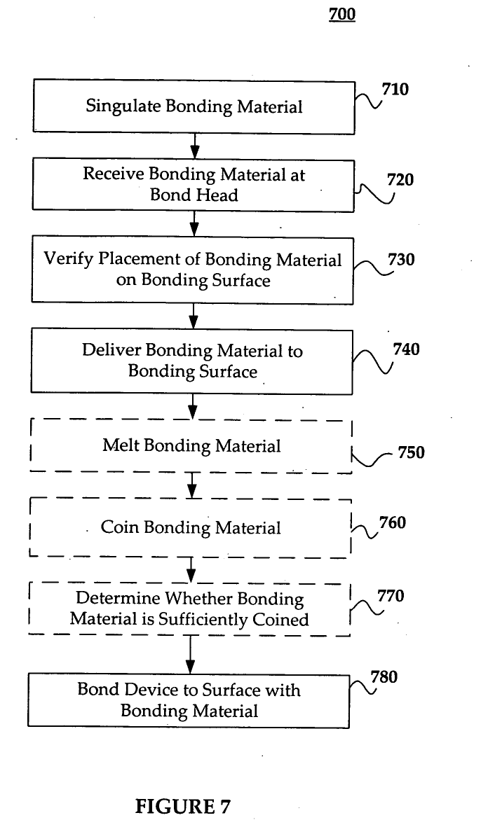

FIG. 7 is an exemplary method 700 for utilizing the presently described solder ball placement system. In step 710, bonding material is singulated by a singulation unit, which may control various properties of the bonding material (e.g., a solder ball) such that it conforms to a particular diameter or pattern—symmetrical or arbitrary (e.g., non-symmetrical). Singulation unit (in step 710) may further control the size, position, and pitch of the bonding material. Bonding material may constitute a variety of materials including euctectic and high lead SnPB as well as lead free SnAg, SnAgCu, and AuSn in addition to other materials as described in the present specification or as otherwise known in the art.

In step 720, the singulated bonding material is received at the bond head for eventual placement on a substrate, chip, or other bonding surface. Placement of the bonding material may take place via a capillary in the bond head and, for example, a vacuum ejector controlling the actual deposit of the bonding material on the bonding surface.

The particular placement of the bonding material then takes place at step 730. Placement of the material may be controlled manually (through a user controlled computing device) or automatically according to a preset specification at, for example, a computing device coupled to the placement system and otherwise controlling the movement of the bond head along a variety of axes. Placement of the bonding material in step 730 may be optimized (i.e., increased accuracy of placement) through the use of a laser and/or optical sensor as previously described. In step 740, the bonding material is delivered to the bonding surface.

At optional step 750, the bonding material may be melted utilizing a laser to improve interface qualities between the bonding surface and the device being bonded thereto. In a further optional step (step 760), the bonding material may be coined if coining is a part of the bonding process. A pressure sensor may (in optional step 770) determine whether a bonding material has been sufficiently coined subject to particular specifications as may be determined by a computing device processing various pressure readings from the pressure sensor. In step 780, a device is bonding to the bonding surface utilizing the bonding material placed thereon.

While the present invention has been described with reference to an exemplary embodiment, it will be understood by those skilled in the art that various changes may be made and equivalents may be substituted for elements thereof without departing from the true spirit and scope of the present invention. In addition, modifications may be made without departing from the essential teachings of the present invention.

What is claimed is:

1. A solder ball placement system, comprising:
a singulation unit configured to singulate a plurality of solder balls; and
a bond head coupled to the singulation unit and configured to receive one or more of the plurality of solder balls from the singulation unit, the bond head further configured to deliver the one or more of the plurality of solder balls to a substrate or chip, the bond head comprising:
a tool tip configured to conduct electricity at a rate sufficient to prevent charge buildup but not at so high a rate as to overload a device being bonded to the substrate or chip; and
a capillary configured to position the one or more of the plurality of solder balls for delivery to the substrate or chip.

2. The solder ball placement system of claim 1, further comprising an optical sensor configured to operate in conjunction with the bond head and optimize placement of the one or more of the plurality of solder balls on the substrate or chip.

3. The solder ball placement system of claim 1, further comprising a laser.

4. The solder ball placement system of claim 3, wherein the laser is configured as a target light for locating one or more of the plurality of solder balls on the chip or substrate.

5. The solder ball placement system of claim 4, wherein the laser operates in conjunction with an optical sensor configured to operate in conjunction with the bond head and optimize placement of the one or more of the plurality of solder balls on the substrate or chip.

6. The solder ball placement system of claim 3, wherein the laser is a solid state, pulsed Nd:YAG laser.

7. The solder ball placement system of claim 6, wherein the laser is configured to operate at a wavelength of approximately 1064 nm.

8. The solder ball placement system of claim 6, wherein the laser is configured to operate with laser energy of 4 J.

9. The solder ball placement system of claim 6, wherein the laser is configured to operate at a pulse frequency of 10 Hz.

10. The solder ball placement system of claim 6, wherein the laser is configured to operate at a width of approximately 1 ms to 20 ms.

11. The solder ball placement system of claim 3, wherein the laser is configured to melt the one or more of the plurality of solder balls whereby the chip or substrate is wetted to improve an interface with a device being bonded.

12. The solder ball placement system of claim 1, further comprising a pressure sensor configured to determine when the one or more of the plurality of solder balls has been sufficiently coined.

13. The solder ball placement system of claim 1, further comprising a vacuum ejector coupled to the capillary, the vacuum ejector configured to control ejection of the one or more of the plurality of solder balls on to the surface of the substrate or chip.

14. The solder ball placement system of claim 1, wherein the bond head is further configured to move on an x-y-z-axis and wherein motion of the bond head along the x-y-z-axis is controlled by a computing device offering directional control of the bond head to a user of the ball placement system.

15. The solder ball placement system of claim 1, wherein the tool tip of the bond head is capable of sequentially soldering the plurality of solder balls.

16. The solder ball placement system of claim 1, wherein the diameter of the plurality of solder balls are between 100 μm and 760 μm.

17. The solder ball placement system of claim 1, wherein the tool tip of the bond head comprises a uniform extrinsic semi-conducting material on an insulator.

18. The solder ball placement system of claim 1, wherein the tool tip of the bond head comprises a thin layer of a highly doped semi-conductor on an insulating core.

19. The solder ball placement system of claim 1, wherein the tool tip of the bond head comprises a lightly doped semi-conductor layer on a conducting core.

20. A device bonded to a chip or substrate by a solder ball deposited on the chip or substrate by a bond head, the bond head comprising a tool tip configured to conduct electricity at a rate sufficient to prevent charge buildup but not at so high a rate as to overload the device bonded to the substrate or chip.

21. A method for placement of a solder ball on a substrate or chip, the method comprising:
singulating at least one solder ball;
receiving the at least one solder ball at a bond head; and
delivering the at least one solder ball to the substrate or chip via a capillary and tool tip, the tool tip configured to conduct electricity at a rate sufficient to prevent charge buildup but not at so high a rate as to overload a device being bonded to the substrate or chip.

22. The method of claim 21, further comprising utilizing an optical sensor to optimize delivery and accurate placement of the at least one solder ball on the substrate or chip.

23. The method of claim 21, further comprising utilizing a laser as a target light to optimize delivery and accurate placement of the at least one solder ball on the substrate or chip.

24. The method of claim 21, further comprising melting the at least one solder ball to wet the chip or substrate for the purpose of improving an interface with the device being bonded.

25. The method of claim 21, further comprising:
coining the at least one solder ball; and
determining whether the at least one solder ball has been sufficiently coined through use of a pressure sensor.
